(19) United States
(12) Patent Application Publication
(10) Pub. No.: US 2003/0127558 A1
(43) Pub. Date: Jul. 10, 2003

(54) System and a method for detecting and countering laser threats and underwater objects for underwater vehicles

(75) Inventor: Gebhard Heizmann-Bartels, Molfsee (DE)

Correspondence Address: COHEN, PONTANI, LIEBERMAN & PAVANE, Suite 1210, 551 Fifth Avenue, New York, NY, 10176, US

(73) Assignee: Howaldtswerke-Deutsche Werft AG

(21) Appl. No.: 10/274,076

(22) Filed: Oct. 18, 2002

(30) Foreign Application Priority Data
Oct. 18, 2001 (DE) 101 51 597.9

(51) Int. Cl. F41G 7/00; F42B 10/00; F42B 15/01; G06F 19/00

(52) U.S. Cl. 244/3.16

(57) ABSTRACT

A system for underwater vehicles for detecting and countering laser threats includes laser detectors and associated equipment to be placed in an underwater vehicle for providing protection of underwater vehicles. Detectors for detecting lasers are arranged on the surface of the underwater vehicle and controlled by a laser warning receiver and a signal processor. The risk of detection of the underwater submarine by laser radiation is reduced as a result thereof. Equipment for detecting and diverting objects are also arranged on the surface of the vehicle. The equipment for detecting and diverting objects are connected together and controlled by a laser control processor. The laser control processor directly communicates with a system for guiding weapons and with the laser warning receiver and signal processor.

### BACKGROUND OF THE INVENTION

1. Field of the Invention

The present invention relates to a system and a method for detecting and countering laser threats and underwater objects in underwater vehicles using laser detectors. The invention also relates to the associated equipment to be placed in an underwater vehicle for providing protection of the underwater vehicle.

2. Description of the Related Art

Laser threats are defined as lasers that are used from other platforms for detecting an underwater vehicle or that are used by laser-controlled weapons such as torpedoes.

The use of lasers for recognizing underwater objects is well known in the art. According to the state of the art, submarines are threatened by other platforms fitted with active laser measuring and locating systems.

In air reconnaissance, airborne platforms increasingly employ laser measuring equipment capable of detecting and locating submerged operating submarines (e.g., the system “April Showers” of Kaman Aerospace Corporation, USA).

Underwater threats such as hostile submarines, torpedoes and unmanned underwater vehicles may also be equipped with lasers. However, conventional submarines are not yet capable of detecting laser radiation.

Furthermore, conventional submarines are not equipped with onboard laser systems for detecting other underwater objects and for assisting in warding these off. Accordingly, no protection against laser threat currently exists for submarines.

Also, conventional submarines are not provided with laser warning systems for underwater laser sources and for laser radiation by surface ships and by airborne reconnaissance platforms (e.g., Maritime Patrol Aircrafts and helicopters).

For diverting attacking torpedoes, conventionally constructed submarines are only equipped with acoustic counter-measures including camouflage, radar jamming and decoys. No protection of submarines against laser threat and laser-guided weapons exists. Acoustic counter-measures are ineffective against laser-guided weapons.

### SUMMARY OF THE INVENTION

An object of the present invention is to provide a system and a method which provide sufficient protection for underwater vehicles in a continuous space surrounding the underwater vehicles by detecting laser radiation emitted in the air (laser radiation which undergoes a medium transfer) and in water (laser radiation which remains in the same medium). The system and method may also be suited for implementing active counter-measures against such threats and may also permit detection of other underwater objects.

The object of the invention is achieved by a system for detecting and countering laser threats and underwater objects for underwater vehicles which includes means for detecting lasers arranged on the surface of the vehicle. The means for detecting are connected together and controlled by a laser warning receiver and a signal processor. The inventive system reduces the risk that the submarines will be detected by laser radiation.

Means for detecting and diverting objects may additionally be arranged on the surface of the vehicle with the means for detecting lasers. The means for detecting lasers are connected together through the laser warning receiver and a signal processor and the means for detecting and diverting objects are connected together and controlled by a laser control processor. The laser control processor directly communicates with a system for guiding weapons and with the laser warning receiver and the signal processor. This ensures that other underwater objects may be detected and diverted by laser warning and by the utilization of lasers onboard the underwater vehicle in which the system is installed.

The means for detecting lasers may include pressure-resistant laser detector sensors designed to detect laser threats. The means for detecting lasers may be arranged on the surface of the vehicle such that the acquisition ranges of the individual means for detecting lasers overlap, thereby providing continuous coverage of a space surrounding the underwater vehicle.

The laser warning receiver and signal processor includes means for receiving, evaluating and analyzing the laser signals received and for classifying them into a data bank.

The system for guiding weapons also includes means for evaluating and analyzing the signals received and for classifying them into a data bank.

The means for detecting and diverting objects may comprise pressure-resistant lasers operating in a scan mode.

According to a particular embodiment of the present invention, the means for detecting objects and the means for diverting objects are arranged separately on the surface of the vehicle. The means for detecting objects include lasers distributed over the surface of the vehicle intended for detecting objects in a continuous space surrounding the underwater vehicle, whereas the means for diverting objects include defense lasers distributed over the surface of the vehicle are intended for fighting objects in a continuous space surrounding the underwater vehicle.

Furthermore, the system for guiding weapons may communicate with torpedo decoys through a Torpedo Counter-Measure System.

The object of the invention is also achieved by a method for detecting and countering laser threats and underwater objects for underwater vehicles. In accordance therewith, means for detecting lasers arranged on the surface of the vehicle provide an all-round spatial coverage of the vehicle by the overlap of the acquisition ranges of the individual means. The method includes the step of transmitting laser signals detected by the means for detecting lasers to a laser warning receiver and signal processor. The means thereby scan the surroundings of the vehicle with regard to objects to be detected, using the scan mode.

The laser signals are then received, evaluated, analyzed and classified into a data bank by the laser warning receiver and signal processor. A data telegram is issued as at least one of a laser warning and a laser alert with local position determination in the result thereof. The data telegram of laser warning and laser alert is transmitted to a system for guiding weapons that is capable of initiating counter-reactions.

According to another embodiment, means for detecting and diverting objects are also arranged on the surface of the vehicle to provide coverage of a continuous space surrounding the vehicle. These means are connected together and controlled via a laser control processor. The means for detecting and diverting objects vertically and horizontally scan the surroundings of the vehicle with regard to objects to be detected. The signals detected by these means are transmitted to the laser warning receiver and signal processor.

The signals are received, evaluated, analyzed and classified into a data bank by the laser warning receiver and signal processor. A data telegram is issued as an object alarm with local position determination in the result thereof. The data telegram of the object alarm is transmitted to the system for guiding weapons which is capable of initiating counter-reactions.

The laser warning receiver and signal processor includes means for receiving, evaluating and analyzing the laser signals received and for classifying them into a data bank. Depending on the reception conditions of laser warning receiver and signal processor, degradations of the results are issued at least in the form of a data telegram as a laser warning.

Evaluation and analysis of the signals and classification into a data bank are also performed by the system for guiding weapons. Manual and/or automatic counter-reactions are initiated through an onboard active laser system and/or through torpedo decoys of a Torpedo Counter-Measure System by the system for guiding weapons. The data telegrams including the laser warning or the laser alert are thereby transmitted from the laser warning receiver and signal processor to the laser control processor.

The present invention permits distribution of a suitable laser warning system and an active laser system designed to counter laser threats over the surface of the underwater vehicle such that protection is provided in a continuous space surrounding the underwater vehicle. The system alerts and warns the crew. It allows the system for guiding weapons of the submarine to initiate a manually and/or automatic controlled counter-reaction by a Torpedo Counter-Measure System. The high precision of the threat data obtained allows a hardkill reaction against attacking torpedoes. This is not possible with the existing acoustic information which is not sufficiently precise. Heretofore, the detection of other underwater objects has only been possible using acoustic active or passive interrogator/responder systems (i.e., sonar systems). The complete coverage by laser of the continuous space surrounding the underwater vehicle provides additional protection against stationary (e.g., mines) and dynamic objects (e.g., enemy submarines, unmanned underwater vehicles, and supercavitating objects).

Other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. It should be further understood that the drawings are not necessarily drawn to scale and that, unless otherwise indicated, they are merely intended to conceptually illustrate the structures and procedures described herein.

### BRIEF DESCRIPTION OF THE DRAWINGS

In the drawings, wherein like reference characters denote similar elements throughout the several views:

FIG. 1 is a schematic view showing the arrangement of a submarine laser and laser warning system according to the present invention in a scenario of a typical mission;

FIG. 2 is a block diagram of the submarine laser and laser warning system according to an embodiment of the present invention; and

FIG. 3 is a block diagram of the submarine laser and laser warning system according to another embodiment of the present invention.

### DETAILED DESCRIPTION OF THE PRESENTLY PREFERRED EMBODIMENTS

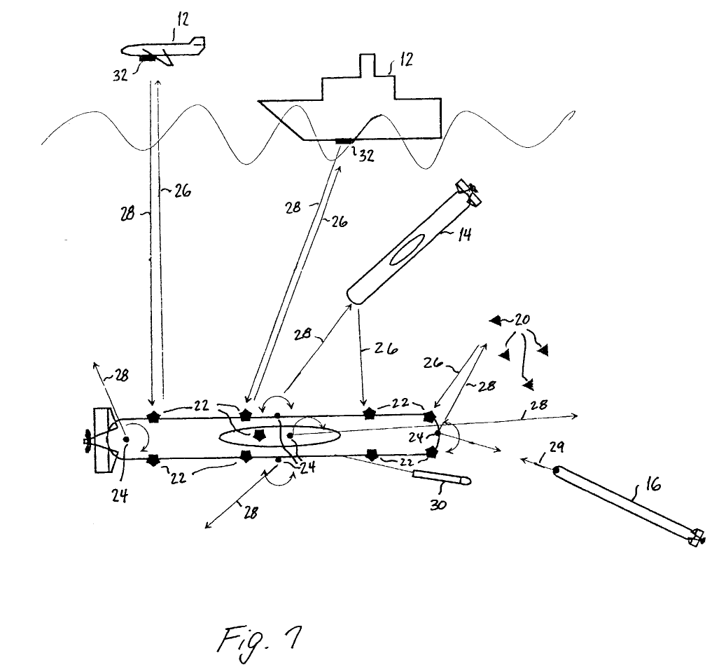

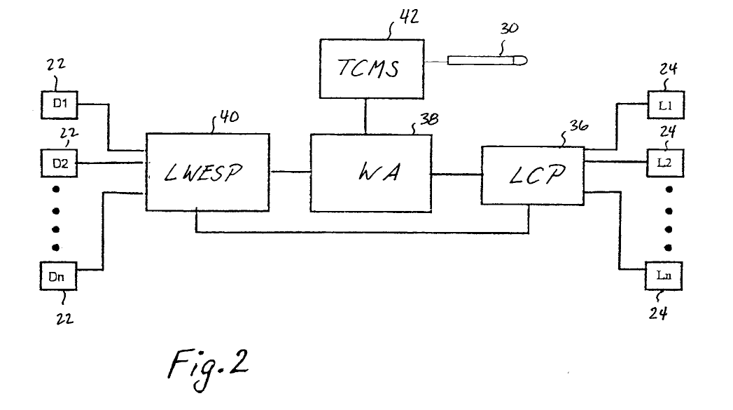

FIGS. 1 and 2 show a submarine laser and laser warning system according to the present invention. Pressure-resistant laser detector sensors 22 designed to detect laser threats are distributed over the surface of an underwater vehicle such as a submarine 10. The laser threats may include laser beams 28 issued from transceivers 32 or other platforms on objects 12 such as reconnaissance planes or ships or control laser beams 29 issuing from laser controlled weapons such as laser guided torpedo 16. The reflections 26 of the laser beams 28 are used to locate the underwater vehicle 10.

The laser detector sensors 22 are distributed on the surface of the underwater vehicle so that the acquisition ranges of the individual sensors 22 overlap, thereby providing complete coverage in a continuous space surrounding the submarine 10. The individual laser detector sensors 22 are connected together at a laser warning receiver and signal processor (LWESP) 40 as shown in FIG. 2. The LWESP 40 includes receiver and processor cards required to receive, evaluate and analyze the laser signals received from the laser detector sensors 22 and to classify the signals into a data bank. The result of signal processing, i.e., the analysis and classification of the laser signal, is issued as a laser alert including the local position determination in the form of a data telegram. Furthermore, a degradation in the results obtained, depending on the reception conditions or other influences, may be issued as a laser warning, also in the form of a data telegram.

The minimum equipment required for the laser warning function is one laser warning detector. However, one laser warning detector offers only limited spatial coverage.

The data telegrams of the laser alert and of the laser warning, respectively, are transmitted to the system for guiding weapons 38 of the submarine through a suitable interface. The system for guiding weapons 38 may also include a processor module of its own that analyzes and classifies the laser signals and also performs the necessary task of comparing the data banks. The system for guiding weapons 38 may initiate a manual and/or automatic counter-reaction by the onboard active laser system and/or torpedo decoys 30 of a Torpedo Counter-Measure System (TCMS) 42, if such a system is available.

The minimum equipment required for providing the laser warning includes an station of the LWESP 40 which is operated from a video display terminal such as, for example, a laptop.

Suitable pressure-resistant lasers 24 designed to detect objects (such as submarines, mines, and so on) and divert them (e.g., laser-guided torpedoes) are distributed over the surface of the submarine 10. The pressure resistant lasers 24 are distributed such that coverage of a continuous space surrounding the submarine by the lasers operated in the scan mode is provided.

The minimum equipment required for the detection of objects is only one laser. However, the minimum requirement permits limited spatial coverage.

The lasers 24 are controlled by laser control processor (LCP) 36 and scan the surrounding space in vertical and horizontal directions. Scanning methods are thereby preferably utilized, e.g., Conical Scan or other scanning methods in common use in radar technique for example. The LCP 36 is directly connected to the system for guiding weapons 38 and to the LWESP 40. For reasons of redundancy, it is necessary to transmit the information of the data telegrams for laser warnings and laser alerts from the LWESP 40 to the LCP 36.

The high precision of the threat data obtained by the LWESP 40 allows laser beams 28 to be directed onto attacking laser-guided enemy underwater objects 14 (e.g., torpedoes 16) for the purpose of deceiving, decoying and/or dazzling/destroying. The term “dazzling” is used herein to mean that the laser sensor technology of the attacking laser-guided enemy underwater object 14 is dazzled by the submarine laser 28. As a result thereof, the receiving optoelectronic system of the attacking underwater object's laser sensor technology is temporarily or permanently “blinded”, thereby eliminating the self-guiding capability of the attacking underwater object 14. The term “destroying” is used herein to mean that the sensitive receiving optoelectronic system of the laser sensor technology of the attacking underwater object 14 is destroyed by the submarine laser 28. This “destroying” action is even stronger than “dazzling”, but yields the same result as to the self-guiding capability.

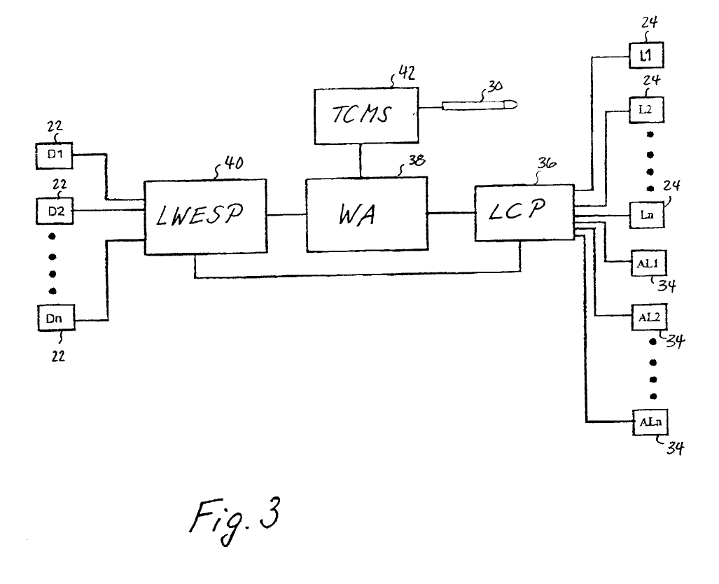

In an alternative embodiment illustrated in FIG. 3, the lasers for detecting objects 24a and the lasers for diverting objects, i.e., defense lasers 34, are separated. The additional defense lasers 34 are distributed over the submarine 10 such that spatial coverage is provided in a continuous space surrounding the submarine. The minimum configuration utilizes one defense laser 34.

Thus, while there have shown and described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

What is claimed is:

1. A system for use in an underwater vehicle for detecting and countering laser threats and underwater objects, comprising:
means for detecting lasers adapted to be arranged on a surface of the underwater vehicle; and
a laser warning receiver and signal processor connected to said means for detecting lasers for controlling said means for detecting lasers.

2. The system of claim 1, further comprising:
means for detecting and diverting objects adapted to be arranged on the surface of the underwater vehicle;
a laser control processor connected to said laser warning receiver and signal processor and connected to said means for detecting and diverting objects for controlling said means for detecting and diverting objects; and
a system for guiding weapons, said laser control processor connected for directly communicating with said system for guiding weapons.

3. The system of claim 1, wherein said means for detecting lasers comprise pressure-resistant laser detector sensors adapted to detect laser threats.

4. The system of claim 3, wherein each of said means for detecting lasers comprises an acquisition range, said means for detecting being adapted to be arranged on the surface of the vehicle to provide coverage of a continuous space surrounding the vehicle by an overlap of the acquisition ranges of individual ones of said means for detecting lasers.

5. The system of claim 1, wherein each of said means for detecting lasers comprises an acquisition range, said means for detecting lasers being adapted to be arranged on the surface of the vehicle to provide coverage of a continuous space surrounding the vehicle by an overlap of the acquisition ranges of individual ones of said means for detecting lasers.

6. The system of claim 1, wherein said means for detecting lasers are adapted to generate laser signals in response to a detection of a laser, and said laser warning receiver and signal processor comprises means for receiving, evaluating, and analyzing the laser signals received from said means for detecting lasers and classifying the received laser signals into a data bank.

7. The system of claim 2, wherein said means for detecting lasers and said means for detecting and diverting objects are respectively adapted to generate signals in response to a detection of a laser and an object, and said system for guiding weapons comprises means for evaluating and analysing the signals received from said means for detecting lasers and said means for detecting and diverting objects and for classifying the received signals into a data bank.

8. The system of claim 2, wherein said means for detecting and diverting objects comprise pressure-resistant lasers operable in a scan mode.

9. The system of claim 2, wherein said means for detecting and diverting objects comprise separate means for detecting objects and means for diverting objects, said means for detecting objects comprise lasers distributed over the surface of the vehicle to detect objects in a continuous space surrounding the vehicle and said means for diverting objects comprise defence lasers distributed over the surface of the vehicle for countering objects in a continuous space surrounding the vehicle.

10. The system of claim 2, further comprising a torpedo counter-measure system including torpedo decoys, said system for guiding weapons being connected with said torpedo counter-measure system for communication with said torpedo decoys.

11. A method for use with an underwater vehicle for detecting and countering laser threats and underwater objects, the underwater vehicle including means for detecting lasers arranged on a surface of the vehicle to provide coverage of a continuous space surrounding the vehicle by overlapping acquisition ranges of individual ones of the means for detecting lasers, the method comprising the steps of:
generating a laser signal at the means for detecting lasers in response to a detected laser;
transmitting the laser signal from the means for detecting lasers to a laser warning receiver and signal processor;
receiving, evaluating, analysing, and classifying the received laser signal in a data bank by the laser warning receiver and signal processor;
issuing a data telegram, by the laser warning receiver and signal processor, including at least one of a laser warning and a laser alert for the laser signal and a local position determination for the at least one of a laser warning and a laser alert; and
transmitting the data telegram for the laser signal to a system for guiding weapons in the underwater vehicle that is adapted to initiate counter-reactions.

12. The method of claim 11, wherein the underwater vehicle further includes means for detecting and diverting objects arranged on the surface of the underwater vehicle to provide coverage of a continuous space surrounding the underwater vehicle by overlapping acquisition ranges of individual ones of the means for detecting and diverting objects, and a laser control processor connected to the means for detecting and diverting objects, said method further comprising the steps of:
controlling the means for detecting and diverting objects by the laser control processor for vertically and horizontally scanning the space surrounding the underwater vehicle;
generating an object signal in the means for detecting and diverting in response to the detection of an object;
transmitting the object signal to the laser warning receiver and signal processor;
receiving, evaluating, analysing, and classifying the received object signal in a data bank by the laser warning receiver and signal processor;
issuing a data telegram, by the laser warning receiver and signal processor, including at least one of a laser warning and a laser alert for the object signal and a local position determination for the at least one of a laser warning and a laser alert; and
transmitting the data telegram for the object signal to a system for guiding weapons in the underwater vehicle that is adapted to initiate counter-reactions.

13. The method of claim 12, further comprising the step of issuing a telegram comprising a degradation of results as a laser warning, by the laser warning receiver and signal processor, based on reception conditions at the laser warning receiver and signal processor.

14. The method of claim 12, further comprising the step of evaluating, analysing, and classifying the object signals in a data bank by the system for guiding weapons.

15. The method of claim 12, further comprising the step of initiating, by the system for guiding weapons, a counter-reaction through one of a laser system and a torpedo decoy of a torpedo counter-measure system in response to at least one of the data telegram for the laser signal and the data telegram for the object signal.

16. The method of claim 12, wherein said step of controlling comprises controlling the means for detecting and diverting objects by the laser control processor in a scan mode for detecting objects.

17. The method of claim 12, further comprising the step of transmitting the data telegram from the laser warning receiver and signal processor to the laser control processor.

18. The method of claim 11, further comprising the step of issuing a telegram comprising a degradation of results as a laser warning, by the laser warning receiver and signal processor, based on reception conditions at the laser warning receiver and signal processor.

19. The method of claim 11, further comprising the step of evaluating, analyzing, and classifying the received laser signals in a data bank by the system for guiding weapons.

20. The method of claim 11, further comprising the step of initiating, by the system for guiding weapons, a counter-reaction through one of a laser system and a torpedo decoy of a torpedo counter-measure system.
